(19) United States
(12) Patent Application Publication
(10) Pub. No.: US 2020/0200251 A1
(43) Pub. Date: Jun. 25, 2020

(54) ACTUATOR WITH WHEEL PROVIDED WITH AXIAL TOOTHING

(71) Applicant: ELECTRICFIL AUTOMOTIVE, Beynost (FR)

(72) Inventors: Laurent ROUSSEL, Saint-Priest (FR); Raphaël MONAVON, Lyon (FR)

(73) Assignee: ELECTRICFIL AUTOMOTIVE, Beynost (FR)

(21) Appl. No.: 16/642,101

(22) PCT Filed: Aug. 27, 2018
(86) PCT No.: PCT/FR2018/052104

§ 371 Date: Feb. 26, 2020

(30) Foreign Application Priority Data
Sep. 8, 2017 (FR) 1758291

(51) Int. Cl. F16H 55/17; F16H 1/12; H02K 7/116

(52) U.S. Cl. CPC F16H 55/17; F16H 2055/173; H02K 7/116; F16H 1/12

(57) ABSTRACT

The invention proposes an actuator for a component of a land motor vehicle, of the type including an actuator casing (12) which is produced by injection molding of thermoplastic polymer material and which delimits an internal volume in which are arranged:
at least one electric motor (16),
and an internal mechanical transmission (18) comprising at least a first gear wheel (24), which has an axis of rotation (A2) perpendicular to the axis of rotation (A1) of the drive shaft (20),
characterized in that the first gear wheel (24) has a toothing (28), called axial toothing, which is formed of gear teeth having a bottom-top extension according to the direction of the axis of rotation (A2) of the first gear wheel (24), and which meshes with the output pinion (22) of the electric motor (16).

The invention relates to the field of actuators for actuating a component of a land motor vehicle.

This type of vehicle must meet well-known usage constraints, but also known economic constraints which in particular require the use, for all the components of the vehicle, of construction and assembly techniques compatible with all of the constraints. In particular, the constraints of production costs are taken into account by those skilled in the art when they seek to design components for these vehicles.

In general, in this field, the actuators envisaged in the invention include a casing which delimits an internal volume in which are arranged at least one electric motor and one internal mechanical transmission which includes at least a first gear wheel. The internal mechanical transmission allows transmitting a movement generated by the electric motor to an output member of the actuator which will control the displacement of another component of the vehicle, associated with this actuator.

This associated component can be for example a component called “drive component”, necessary for the operation of an internal combustion engine of the vehicle. In one application, the drive component may be a flap for controlling the air flow rate in an air supply circuit of the internal combustion engine of the vehicle. This control flap is generally called “intake throttle valve”. In known manner, the operating constraints for the drive components are relatively severe, in particular in terms of operating temperature range. However, being a component arranged on the intake side of the internal combustion engine, the operating constraints are relatively less severe than for a component arranged on the exhaust side of the internal combustion engine.

In the field of the considered land motor vehicles, the other constraints, in particular of weight and production cost, taken in combination, tend to push those skilled in the art to choose, for the production of the casing of such an actuator, the techniques of injection molding of thermoplastic polymer material. This technology allows obtaining, for controlled production costs, casings including complex shapes ensuring multiple secondary functions, in particular functions of protecting, fixing, positioning all the elements comprised in the internal volume of the actuator, including the electric motor and the first gear wheel.

The internal mechanical transmission to the casing of the actuator can have at least either of the following two functions: a first function of changing the orientation of the movement of the output shaft of the electric motor, in particular a function of angle transmission, and/or optionally a function of increasing/reducing the speed of the movement.

The presence of an angle transmission mechanism can be important to obtain an appropriate general configuration of the actuator as a function of a total overall dimension of the actuator and as a function of the possible spatial positioning for this actuator in the environment in which it must be integrated. Thus, in the case of an application to actuate a drive component, the engine environment is generally very constrained and does not allow any orientation, in particular of the electric motor, relative to the other surrounding components.

In particular, in some cases, it is favorable to provide that the first gear wheel has an axis of rotation perpendicular to the axis of rotation of the output shaft of the electric motor of the actuator, so as to form an angle transmission.

To form an angle transmission mechanism, those skilled in the art generally opt for the use of a two bevel pinion gear. However, the positioning of two bevel pinions relative to each other requires very high accuracy. However, when the casing of the actuator is made of polymer material by injection molding, the manufacturing tolerances that can be obtained for the casing, at reasonable costs in view of the considered application in the field of the land motor vehicles, would require particular precautions and arrangements to allow a sufficiently accurate positioning of the electric motor and of the first gear wheel, or to compensate for any inaccuracy in the relative positioning. For example, it could be provided to increase the modulus of the toothing of the gears to increase the tolerance of such gears to a relative mispositioning. However, this would increase the cost, weight and overall dimension of the parts.

To form an angle transmission mechanism, it also possible to consider using a worm-wheel and worm-screw type gear. However, this type of gear has a very poor mechanical efficiency, which leads to having to oversize the electric motor, which is disadvantageous in terms of weight, cost, and overall dimension. In addition, a worm-wheel and worm-screw gear is generally irreversible. For some applications, this is not acceptable. For example, for the application envisaged above to control an intake throttle valve, it is necessary that, in the event of failure of the electric motor, the intake throttle valve is automatically and mechanically brought back to a predetermined position, in particular an open position. This is generally ensured by a return spring which can be integrated to the actuator, generally at the output member of the actuator, or at the intake throttle valve. In the case of an irreversible gear, such a return spring would not allow bringing the flap back to its predetermined open position if the electric motor were defective in the closed position, since the return force of the spring could not fight against the irreversible nature of the gear, which would be blocked by the motor.

The invention therefore aims at proposing a new design of an actuator for a component of a land motor vehicle, in particular for a vehicle having an empty weight of less than 2.5 tons, which is both compact and economical to produce.

Thus, the invention proposes an actuator for a component of a land motor vehicle, of the type including an actuator casing which is produced by injection molding of thermoplastic polymer material and which delimits an internal volume in which are arranged:
at least one electric motor having a drive shaft on which is mounted an output pinion secured in rotation to the drive shaft, the drive shaft having an axis of rotation,
and an internal mechanical transmission comprising at least a first gear wheel, which has an axis of rotation perpendicular to the axis of rotation of the drive shaft, and which is meshed with the output pinion of the electric motor to transmit a movement of the output pinion of the electric motor to an output member of the actuator.

This actuator is characterized in that the first gear wheel has a toothing, called axial toothing, which is formed of gear teeth having a bottom-top extension according to the direction of the axis of rotation of the first gear wheel, and which meshes with the output pinion of the electric motor.

According to other optional characteristics of the invention:
The first gear wheel can be guided in rotation in the casing with a translational laxity according to the direction of its axis of rotation, and the actuator can include at least one elastic pressing means which urges the first gear wheel according to the direction of its axis of rotation and which presses the axial toothing of the first gear wheel against the output pinion of the electric motor.
The elastic pressing means can include an elastic member.
The elastic pressing means can be a pressing means whose elastic member delivers an axial return force, directed according to the direction of the axis of rotation of the first gear wheel.
The elastic member can be independent of the casing and be interposed between the casing and the first gear wheel.
The elastic member can be a wired spring.
The elastic member can be a tension or compression helically-wired spring.
The axial toothing can be comprised in an annular area of the first gear wheel which extends, with respect to the axis of rotation of the first gear wheel, between an internal diameter and an external diameter, and the elastic member can be bearing against the first gear wheel in a central bearing area comprised inside the internal diameter.
The central bearing area can be comprised inside a central diameter less than half the internal diameter.
The elastic member can be bearing against the first gear wheel with the interposition of at least one intermediate part.
The actuator can include a second gear wheel:
   which is coaxial with the first gear wheel;
   which has a helical cylindrical toothing formed of gear teeth having a bottom-top extension according to directions perpendicular to the direction of the axis of rotation of the first gear wheel and having a lateral extension along helical lines wound at a helix angle about the axis of rotation of the first gear wheel;
   which meshes with a third gear wheel with helical cylindrical toothing.

In this case, it can be advantageously provided that:
the first and second gear wheels are secured to each other in rotation about their common axis and in translation along their common axis;
the first, second and third gear wheels belong to a gear cascade,
and that the elastic member of the pressing means delivers an angular return force to at least one wheel of said gear cascade about the axis of said gear wheel to which the angular return force is applied, the direction of the return force and the direction of the helix angle of the toothing of the second gear wheel being chosen so that the angular return force generates, on the first gear wheel, an axial pressing force towards the output pinion of the electric motor.
The angularly acting elastic member can be a wired spring.
The electric motor and the first gear wheel can be each connected and positioned independently with respect to the casing of the actuator.

Various other characteristics will emerge from the description given below with reference to the appended drawings that show, by way of non-limiting examples, embodiments of the object of the invention.

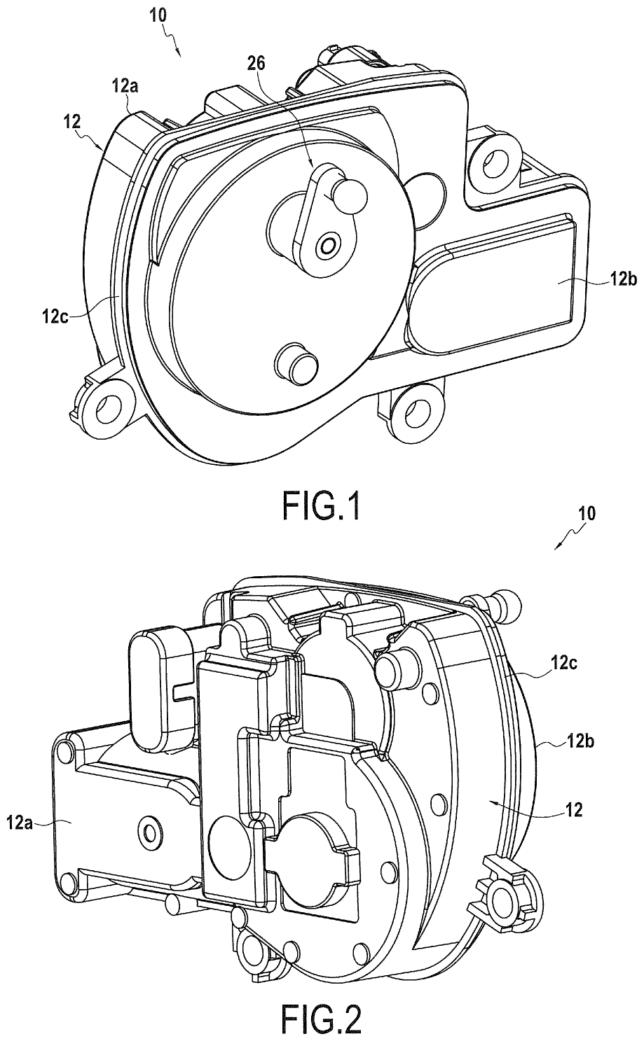

FIGS. 1 and 2 are perspective views of an exemplary embodiment of an actuator for a component of a land motor vehicle, in accordance with the teachings of the invention.

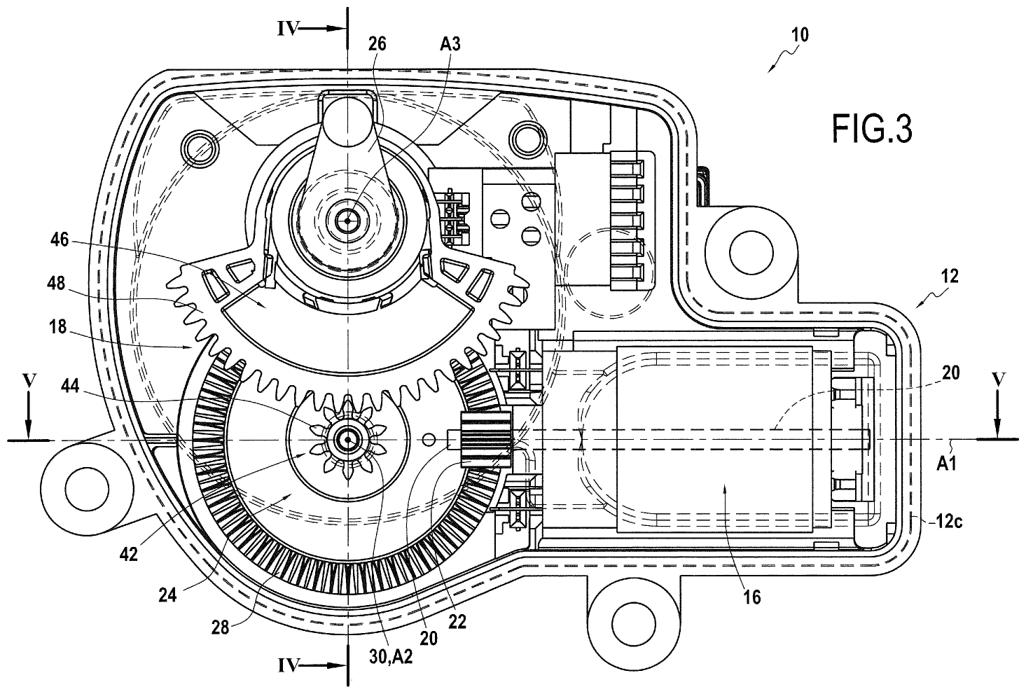

FIG. 3 is a plan and transparent view of the main components of such an actuator inside the casing of the actuator.

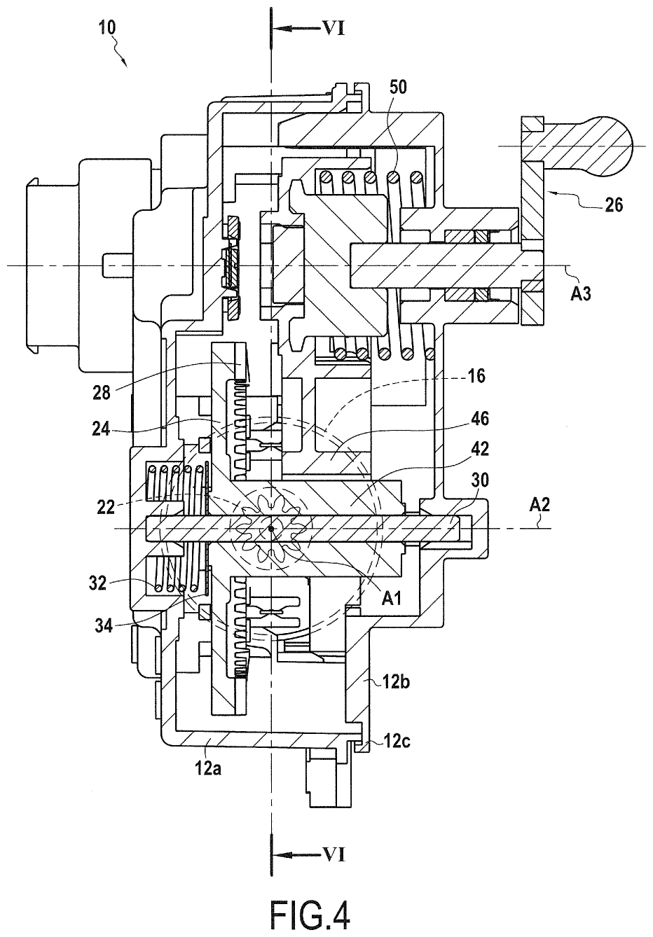

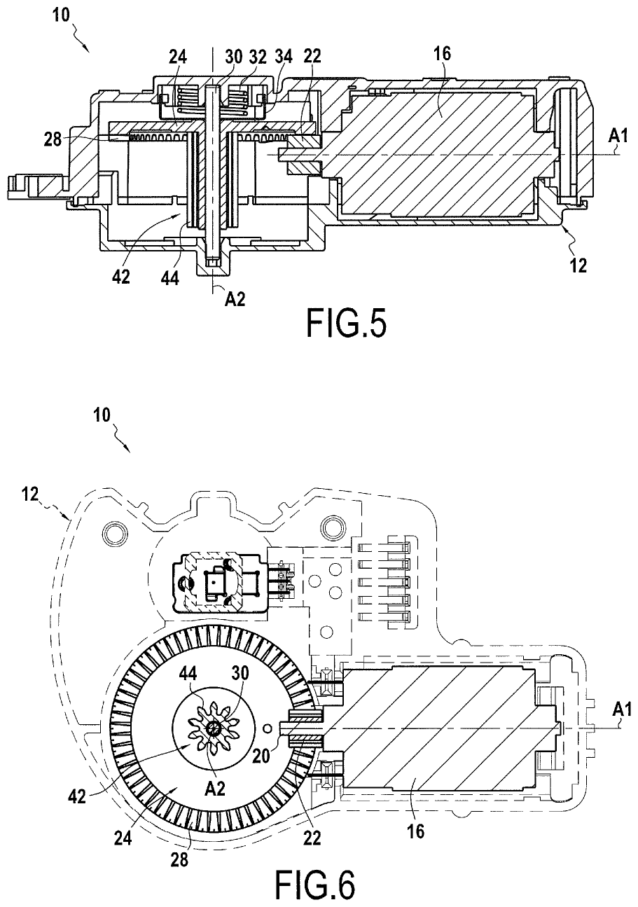

FIGS. 4, 5 and 6 are sectional views, respectively according to the sectional planes A-A, B-B and C-C indicated in FIGS. 3 and 4.

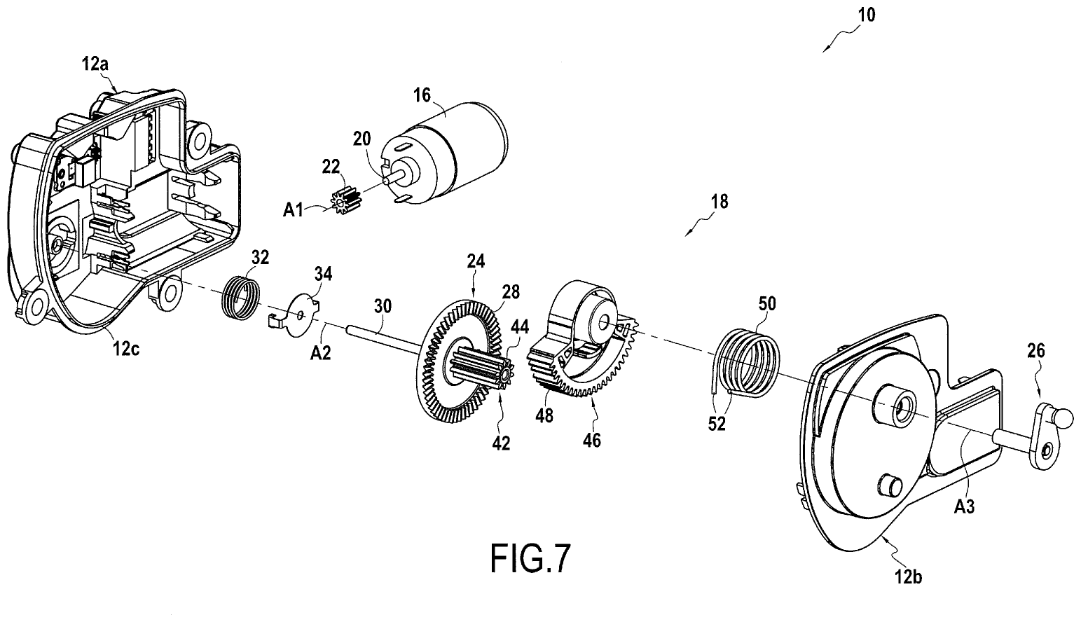

FIG. 7 is an exploded perspective view of the main components of the actuator illustrated in the preceding Figs.

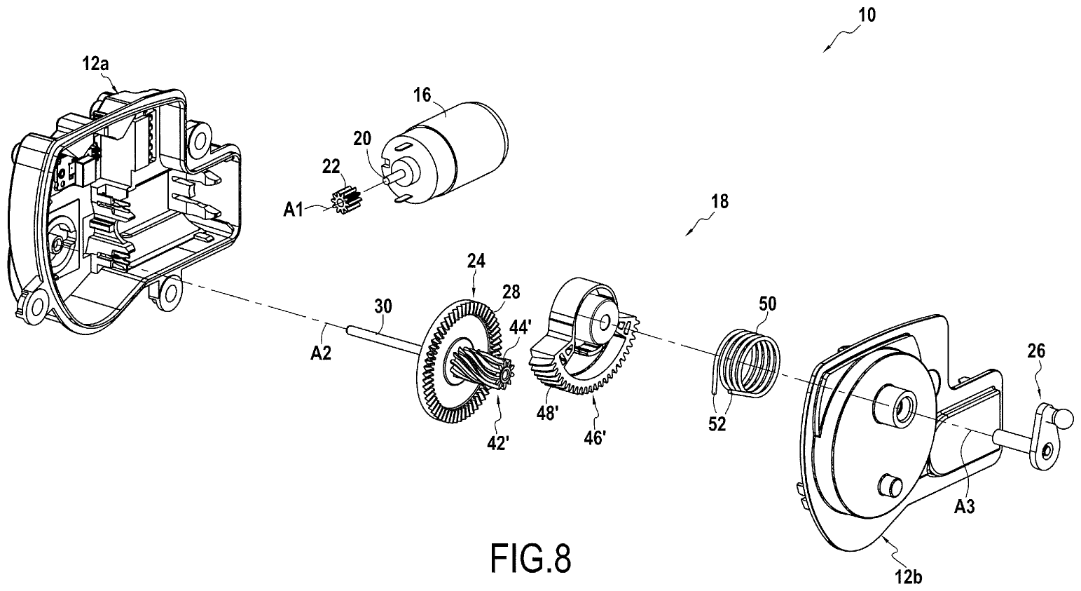

FIG. 8 is a view identical to that of FIG. 7, illustrating a variant of an actuator according to the invention.

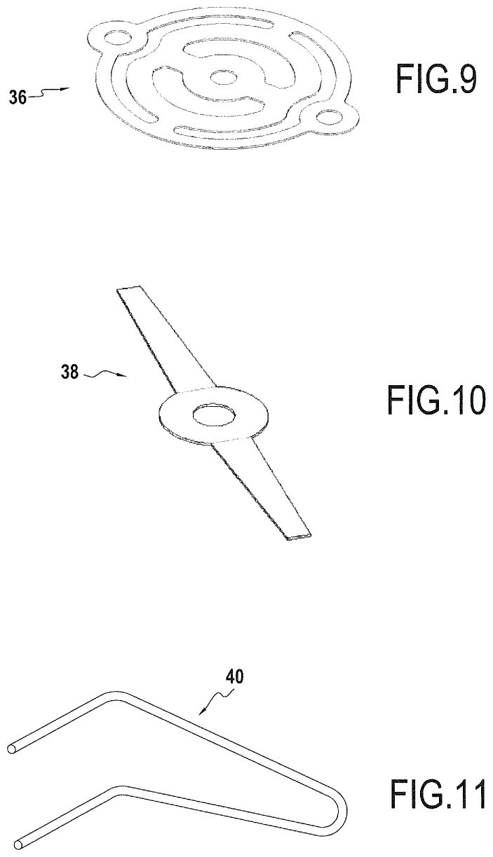

FIGS. 9, 10 and 11 illustrate variants for an elastic pressing member likely to be used in particular in the embodiment of FIG. 7.

The figures illustrate an exemplary embodiment of an actuator 10 for a component of a land motor vehicle.

Such a vehicle is for example a motor vehicle having an empty weight of less than 2.5 tons, the empty weight being defined within the meaning of article R312-1 of the French Highway Code as “the mass of a vehicle in running order comprising the chassis with the accumulators and the water tank filled, the fuel tanks or the gas producers filled, the car body, the normal equipment, the wheels and the spare tires and the ordinary tools normally delivered with the vehicle”.

The actuator 10 is intended to set in motion a component, not represented, of the vehicle. In one application, this component is for example an intake throttle valve for an internal combustion engine of the vehicle. In another application, this component can be a component for locking the vehicle transmission which transmits the movement generated by an engine of the vehicle to the drive wheels of the vehicle, this locking component being commonly called “park lock”.

The actuator 10 includes an actuator casing 12 which is produced by injection molding of thermoplastic polymer material, for example polyamide, polyethylene, polypropylene, polyester, ABS, etc.

The thermoplastic polymer material refers to a material having sufficient rigidity, for a range of ambient temperatures, corresponding to the temperatures of the ambient atmosphere under normal conditions of use, this range of ambient temperatures being lower than the Vicat softening temperature of the material. Sufficient rigidity corresponds to an absence of significant deformation under normal conditions of use. The thermoplastic polymer material has a malleable plastic state in an intermediate forming temperature range, higher than the Vicat softening temperature of the material, in a reversible manner. Such a material regains its initial rigidity when the material is brought back to the range of ambient temperatures, below the

Vicat softening temperature of the material, but can again be brought, at least a second time, into its malleable plastic state by being brought again into the intermediate forming temperature range, above the Vicat softening temperature of the material.

Such a material is therefore not significantly thermally degraded when it is brought into the intermediate forming temperature range. With such a material, the mechanical shear stresses introduced by a shaping method do not significantly modify the molecular structure of the material when the shaping is carried out in this intermediate forming range.

The thermoplastic polymer material can be loaded with reinforcing elements, for example beads or glass fibers. The actuator casing 12 is generally formed of several parts, generally at least two separate parts which are assembled together, for example by elastic interlocking and/or by complementary fasteners such as screws, removable staples or rivets. In the example illustrated, the actuator casing 12 includes two separate portions, namely a rear portion 12a and a front portion 12b. The concepts “front” and “rear” are used here in a purely arbitrary manner with reference to FIGS. 1 and 2. In the example illustrated, these two portions are assembled to each other along a common peripheral edge 12c which, in this example but not necessarily, is contained in a main plane of the actuator.

The casing 12 of the actuator 10, obtained by injection molding of thermoplastic polymer material, may have geometric deviations compared to a theoretical geometry. These geometric deviations are reflected in tolerance intervals, for the usual dimensions for this type of parts, which are greater than 0.1 millimeter. These geometric deviations can in particular be due to the technique of production by injection molding which can generate, in particular during the cooling of the constituent parts of the casing 12, uncontrolled deformations of the part. Of course, the techniques of injection molding of thermoplastic polymer material can allow obtaining smaller geometric deviations, but often at the cost of greater complexity of production, therefore often at a higher economic cost. One of the advantages of the invention is to allow the production of an actuator whose casing can be produced by injection molding of thermoplastic polymer material, at low cost, while guaranteeing satisfactory operation of the actuator, within the operating constraints and with the longevity required within the context of the considered applications.

The actuator casing 12 delimits an internal volume. In the example illustrated, the internal volume, defined between the two rear 12a and front 12b portions, is a closed volume, without opening. Preferably, but not necessarily, this internal volume is closed in a watertight manner by the casing 12.

In a known manner, inside this internal volume, the actuator includes at least one electric motor 16 and an internal mechanical transmission 18 which, in the example illustrated in the figures, includes a cascade of pinions. The electric motor 16 is fixed directly or indirectly in the casing 12, in this case in a housing formed by partitions formed integrally with the rear portion 12a of the casing 12. Optionally, the electric motor 16 is fixed by elastic interlocking in integrally formed corresponding elements during the injection molding of thermoplastic polymer material of the corresponding portion of the casing 12.

The electric motor 16 has a drive shaft 20 on which is mounted an output pinion 22 secured in rotation to the drive shaft, the drive shaft 20 having an axis of rotation A1. In the example illustrated, the axis of rotation A1 of the drive shaft 20 extends parallel to the main plane of the casing 12 of the actuator 10. The electric motor 16 can be of any conventionally used type. Of course, the actuator 10 advantageously includes an electrical connector for powering the motor 16 and preferably a control connector which allows controlling this electric motor by connecting it to an electronic control circuit. Note that part of the electronic control circuit can be comprised inside the casing 12 of the actuator 10.

The internal mechanical transmission 18 comprises at least a first gear wheel 24, which has an axis of rotation A2 perpendicular to the axis of rotation A1 of the drive shaft 20, and which is meshed with the output pinion 22 of the electric motor to transmit, directly or preferably indirectly as in the example which will be described, a movement of the output pinion 22 of the motor 20 to an output member 26 of the actuator 10.

In the example illustrated, the axis of rotation A2 of the first gear wheel 24 is perpendicular to the main plane of the casing 12 of the actuator, so that the wheel 24 in itself has a circular contour which extends in the main plane of the actuator 10, or in a plane parallel thereto, just like the electric motor 16. In other words, the first gear wheel 24 and the electric motor 16 present essentially a maximum overall dimension in this plane, compared to their overall dimension according to a direction perpendicular to this plane.

In the example illustrated, the output member 26 of the actuator is a crank which extends at least partly outside the internal volume and which is intended to control, directly or indirectly, a component of the vehicle.

The movement of the output member 26 of the actuator 10 can be, as in the example illustrated, a rotary movement, here of axis of rotation A3, or it can be a translational movement, or any other movement, including a combination of movements. In the example illustrated, the rotary movement of the output member 26 is limited to an angular range less than 360°, or even less than 180° of angle about the axis of rotation A3 of the output member 26. However, the angular range of the movement could be greater than 360°, or even not limited. In the example illustrated, the output member 26 is a crank which is intended to be connected to the component to be actuated by a transmission mechanism external to the actuator, for example a linkage, including for example at least one tie rod. However, the invention is not limited to such an implementation. It is also possible to provide a direct actuation of the component to be actuated by the output member 26 of the actuator.

According to one aspect of the invention, the first gear wheel 24 has a toothing 28, called axial toothing, which is formed of gear teeth having a bottom-top extension according to the direction of the axis of rotation A2 of the first wheel gear 24, and which meshes with the output pinion 22 of the electric motor 16. It is therefore understood that the toothing 28, taken as a whole, extends along a ring about the axis of rotation A2 of the first gear wheel 24. The toothing 28 therefore has a width corresponding to the extent of the teeth of the toothing 28 according to a radial direction with respect to the axis of rotation A2. Thus, the axial toothing 28 is comprised in an annular area of the first gear wheel 24 which extends, with respect to the axis of rotation A2 of the first gear wheel 24, between an internal diameter “Dint” and an external diameter “Dext”. Such a gear wheel is sometimes called “contrategear” or “face gear”. In the example illustrated, the first gear wheel 24 therefore appears as a disc whose axis is the axis of rotation A2. This disc includes at least one lateral face, here a front lateral face, perpendicular or substantially perpendicular to the axis of rotation A2, from which the extension of each gear tooth lies from its bottom to its top according to the direction of the axis of rotation A2.

In the example illustrated, the axis of rotation A2 of the first gear wheel 24 is not only perpendicular, but also intersecting with the axis A1 of the drive shaft 20 of the electric motor 16. Thus, these two axes of rotation determine a plane. In the example illustrated, this plane is parallel to the main plane of the casing 12 of the actuator 10, separate or not from this plane.

Within the context of the envisaged application, the use of a first axially toothed 28 gear wheel 24 allows forming, with the output pinion 22, an angle transmission, in this case a 90° angle transmission, between the drive shaft 20 and the axis of rotation A3 of the first gear wheel 24. This angle transmission has good mechanical efficiency, generally greater than 80%.

The use of a first axially toothed 28 gear wheel 24 also allows having a reversible angle transmission. Thus, if the electric motor 16 delivers a motor torque to its output pinion 22, the angle transmission allows transmitting the motor torque through the first gear wheel 24 towards a downstream portion of the internal mechanical transmission 18. Conversely, if a motor torque is applied, directly or indirectly, on the first gear wheel 24, for example an elastic return force, the angle transmission allows, in the absence of electrical or mechanical blocking of the motor, rotating the drive shaft 20 of the electric motor 16 without the latter blocking the movement.

As can be seen in the figures, the output pinion 22 of the electric motor 16 can be a straight-toothed cylindrical pinion. Such a pinion has a toothing formed of gear teeth having a bottom-top extension according to radial directions, perpendicular to the direction of the axis of rotation A3 of the shaft 20 of the electric motor 16, and having a lateral extension along straight lines parallel to the same axis of rotation A3.

In the example illustrated, the meshing between the output pinion 22 of the electric motor 16 and the first gear wheel 24 generates, by the differences in pitch diameter between the output pinion 22 and the first gear wheel 24, a reduction of the speed of the output shaft 20 of the motor. Thus, the first gear wheel 24 rotates at a speed of rotation which is for example less than half that of the output pinion 22 of the electric motor 16, preferably less than a quarter of the speed of rotation of the output pinion 22 of the electric motor 16.

Note that the first gear wheel 24 is guided in rotation in the casing about its axis of rotation A2. In this case, the first gear wheel 24 is carried by a shaft 30 coaxial with the first gear wheel 24. The shaft 30 is here produced in the form of a part separate from the first gear wheel 24, but it could be envisaged that the shaft 30 and the first gear wheel 24 are made in one piece, for example by molding. The two axial ends of the shaft 30, on either side of the first gear wheel 24, are each guided in rotation in corresponding housings, arranged respectively in the rear portion 12a and in the front portion 12b of the casing 12. It is thus noted that, in this embodiment, the electric motor 16 of the actuator 10 and the first gear wheel 24 are each connected and positioned independently of the casing 12 of the actuator 10.

In the example illustrated, the first gear wheel 24 is mounted in the casing 12 with a translational laxity, or mechanical clearance, according to the direction of its axis of rotation A2. This translational laxity according to the direction of its axis, permitted by the guide means, is preferably of at least 0.1 millimeter. It will be generally comprised between 0.1 and 1 millimeter, but may in some cases exceed 1 millimeter.

In return for this axial laxity of the mounting of the first gear wheel 24, it can be provided, as in the examples illustrated, that the actuator 10 includes at least one elastic pressing means which urges the first gear wheel 24 according to the direction of its axis of rotation A2 and which presses the axial toothing 28 of this first gear wheel 24 against the output pinion 22 of the electric motor 16, thus ensuring optimal meshing between the output pinion 22 of the electric motor 16 and the first gear wheel 24.

The elastic pressing means can take different forms. For those which will be described below, the elastic pressing means preferably includes an elastic member.

In a first embodiment illustrated in FIGS. 3 to 7, the elastic pressing means is a pressing means whose axially acting elastic member delivers an axial return force, directed according to the direction of the axis of rotation A2 of the first gear wheel 24, this force being applied directly or indirectly on the first gear wheel 24.

In this embodiment, the elastic member can be independent of the casing 12 and be interposed between the casing 12 and the first gear wheel 24. However, in a variant, it is also possible to provide that the elastic member is formed integrally with at least part of the casing 12, during the injection molding operation.

Typically, the elastic member can be a wired spring, in particular a metal wire. As in the example illustrated in FIGS. 3 to 7, it can be a compression helically-wired spring 32. It should however be noted that an actuator could be produced in which the pressing means includes a tension spring also delivering an axial return force along the axis of rotation A2 of the first gear wheel 24.

In the example illustrated, the elastic member 32 is in the form of a compression helically-wired spring and it is arranged between a bottom wall of the rear portion 12a of the casing 12 and a rear lateral face of the first gear wheel 24, opposite the front face on which the axial toothing 28 of the first gear wheel 24 is formed.

In the example illustrated, the elastic member 32 exerts an elastic return force which is not only parallel to the axis of rotation A2 of the first gear wheel 24, but which is also directed along this axis of rotation A2. In other words, the elastic return force applied by the elastic member on the first gear wheel 24 is centered relative to the first gear wheel 24.

In the example illustrated, the elastic member exerts its elastic return force on the first gear wheel 24 by contact with the latter in a central area thereof. As the elastic member 32 can be in contact, directly or indirectly, with the first gear wheel, there is an interest here in the contact between on the one hand the first gear wheel 24 or a part which is connected in rotation therewith, and on the other hand the elastic member 32 which is considered as not rotating relative to the casing 12.

In the example illustrated, the elastic member 32 is bearing against the first gear wheel in a central area comprised inside the internal diameter “Dint” delimiting the annular area of the first gear wheel 24 in which the axial toothing 28 is comprised. Preferably, this central area in which the bearing takes place is comprised inside a central diameter less than half the internal diameter “Dint”. This allows minimizing the effects of the friction, for better efficiency.

The elastic member 32 is preferably bearing against the first gear wheel 24 with the interposition of at least one intermediate part 34. In the example illustrated, this intermediate part is simply a washer 34. The intermediate part is preferably a metal part and/or a part coated with a material with a low coefficient of friction such as a polytetrafluoroethylene (PTFE) based-material, to reduce friction. The intermediate part is for example secured to the first gear wheel in rotation about the axis A2.

It is noted that the elastic member 32 can take other forms. In particular, FIGS. 9 to 11 illustrate a spring with perforated plate 36, a washer with elastic radial branches 38, or a wired spring shaped like a pin 40 whose branches are bent, all three can be used instead of or as a complement to the compression helically-wired spring 32. Such variants can allow reducing the cost of achievement of the function.

In the two embodiments illustrated in FIGS. 7 and 8 the actuator includes a second gear wheel 42, 42′:
which is coaxial with the first gear wheel 24; and
which has a toothing 44, 44′ formed of gear teeth having a bottom-top extension according to directions perpendicular to the direction of the axis of rotation A2 of the first gear wheel 24.

In both cases, the second gear wheel 42, 42′ meshes with a third gear wheel 46, 46′, so that the second and third gear wheels belong to the gear cascade of the internal mechanical transmission 18.

In the examples illustrated, the third gear wheel 46, 46′ has an axis of rotation A3 which is parallel to the axis of rotation A2 of the first gear wheel, and separate therefrom. Specifically to these embodiments, whose angular range of rotation of the output member is less than 360°, the third gear wheel 46, 46′ has a toothing which extends over less than 360° angle.

In both cases, the first gear wheel 42, 42′ and the second gear wheel 46, 46′ are secured to each other in rotation about their common axis of rotation A2, and secured to each other in translation along their common axis of rotation A2. The first gear wheel 42, 42′ and the second gear wheel 46, 46′ can be made in one piece, as in the examples illustrated, or in the form of separate parts connected to each other.

The exemplary embodiment which is illustrated in FIG. 8 is identical in all respects to that of FIG. 7, except for the toothing of the second gear wheel and of the third gear wheel and except for the absence, in the embodiment of FIG. 8, of the pressing means 32, 34, of FIG. 7, whose elastic member delivers an axial return force. Thus, the embodiment of FIG. 8 does not include the axial spring 32 or the intermediate bearing part 34.

In the embodiment of FIG. 7, the toothing 44 of the second gear wheel 42 is a straight cylindrical toothing. Thus, the gear teeth have a lateral extension along a straight line parallel to the axis of rotation A2 of the first gear wheel. The second gear wheel 42 meshes with a third gear wheel 46, which also has a straight cylindrical toothing 48. It is noted that the second gear wheel 42 has a lateral extension greater than that of the third gear wheel 46. It is understood that this allows an optimal gearing despite any uncertainty, according to the axial direction, of the relative position of the second and third gear wheels. This therefore allows benefiting from the axial laxity of the positioning of the first wheel, without jeopardizing the meshing with the third gear wheel. It is understood that, in this embodiment, the meshing of the second gear wheel 42 with the third gear wheel 46 does not generate any force according to the direction of their common axis of rotation A2.

In the embodiment of FIG. 8, the toothing 44′ of the second gear wheel 42′ is a helical cylindrical toothing having a lateral extension along helical lines wound at a helix angle about the axis of rotation A2 of the first gear wheel 24. The second gear wheel 42′ meshes with a third gear wheel 46′ which also has a corresponding helical cylindrical toothing 48′. It is understood that, in this embodiment, the meshing of the second wheel gear 42′ with the third gear wheel 46′ generates a force according to the direction of their respective axes of rotation A2, A3, which force is proportional to the torque transmitted through the gear of the two wheels. The helix angle, which is the acute angle of the tangent to the helix with the generatrix line of the cylinder carrying the helix, is preferably less than 45°, preferably comprised between 10° and 45°, preferably between 15° and 30° (the helix angle is 0 for a straight cylindrical gear).

The torque transmitted through the gear of the second gear wheel 42′ with the third gear wheel 46′ can result, on the one hand, from a motor torque applied by the electric motor on the first gear wheel 24. This torque can also result from any motor or resisting torque which is applied on the gear cascade. This torque which is applied on the gear cascade can be applied directly on one of the gear wheels of the gear cascade, or indirectly, for example on a transmission mechanism external to the actuator connecting the output member 26 to the component to be actuated, or even on the component to be actuated itself.

In the embodiment of FIG. 8, as in that of FIG. 7, an elastic member 50 delivers an angular return force directly or indirectly to at least one gear wheel of said gear cascade, for example to the third gear wheel 46′. This return force is exerted about the axis of rotation A3 of said gear wheel to which the angular return force is applied.

In the example illustrated, this elastic member is an angularly acting spring 50. It is here produced in the form of a helical wire, for example made of metal material. The angularly acting spring has a first bearing arm 52, intended for example to bear against an adequate surface of the casing 12, and a second bearing arm 52, intended for example to bear against an adequate surface of the third gear wheel 46′. In the example, each bearing arm extends with a radial component with respect to the axis of rotation A3 of the gear wheel concerned, each at one end of the helical wire.

In the two embodiments of FIG. 7 and FIG. 8, the first function of this elastic member 50 is to bring the actuator, and therefore the component to be actuated, back to a predetermined position in the absence of any positive control of the motor. Thus, even in the event of failure of the motor or of its power supply, the elastic member 50 brings the assembly back to a predetermined state. This return to the predetermined position is allowed by the reversible nature of the gear between the first gear wheel 24 and the output pinion 22 of the electric motor 16. Of course, it is then ensured that all of the internal mechanical transmission 18, including the cascade of gear wheels 24, 42, 42′, 46, 46′, is also reversible. In particular, in case of helical gears, a helix angle of less than 45° is preferably chosen.

However, in the example of FIG. 8, the elastic member 50 for return to the predetermined position also serves as an elastic pressing member, in the sense that the elastic force generated by this elastic member 50, although being angular, induces, by the presence of the helical gear between the second gear wheel 42′ and the third gear wheel 46′, an axial force according to the direction of their respective axes of rotation A2, A3. The axial force thus exerted on the second gear wheel 42′, is directly reflected on the first gear wheel 24 which is connected thereto in translation along their common axis of rotation A2. This axial force is used as the pressing force of the first gear wheel 24 against the output pinion 22 of the electric motor 16.

Of course, it is necessary to choose the direction of the return force generated by the elastic member 50 and the direction of the helix angle of the toothing 44′ of the second gear wheel 42′, so that the angular return force generates, on the first gear wheel 24, an axial pressing force towards the output pinion 22 of the electric motor 16, and not in the opposite direction. This will be easily determined by those skilled in the art.

This embodiment has the advantage that the pressing force which is imposed on the first gear wheel 24 is an increasing function of the torque which is transmitted at a given time through the internal mechanical transmission 18. This pressing force, which is not fixed, is therefore adapted automatically at any time to the operating conditions of the actuator.

In the embodiment of FIG. 8, the actuator includes a single means for pressing the first gear wheel 24 on the output pinion 22 of the motor, this means being the one comprising the angularly acting elastic member 50. It should however be noted that it is possible to produce an actuator including two pressing means, a first one being of the type with axially acting elastic member, identical or similar to that of FIG. 7, and a second one being of the type with angularly acting elastic member, identical or similar to that of FIG. 8. The first one would be in particular useful in conditions of low torque transmitted through the internal mechanical transmission 18. Its calibration could be less than that of FIG. 7, in which it is the only pressing means. Thus, with two pressing means, an axially acting spring 34 of lower stiffness could be used for the first pressing means, generating in particular less friction losses. The second pressing means would intervene more predominantly for the higher transmitted torque levels.

The invention is not limited to the described and presented examples since various modifications can be made thereto without departing from its scope.

1. An actuator for a component of a land motor vehicle, of the type including an actuator casing (12) which is produced by injection molding of thermoplastic polymer material and which delimits an internal volume in which are arranged:
at least one electric motor (16) having a drive shaft (20) on which is mounted an output pinion (22) secured in rotation to the drive shaft, the drive shaft having an axis of rotation (A1),
and an internal mechanical transmission (18) comprising at least a first gear wheel (24), which has an axis of rotation (A2) perpendicular to the axis of rotation (A1) of the drive shaft (20), and which is meshed with the output pinion (22) of the electric motor (16) to transmit a movement of the output pinion (22) of the electric motor (16) to an output member (26) of the actuator (10),
characterized in that the first gear wheel (24) has a toothing (28), called axial toothing, which is formed of gear teeth having a bottom-top extension according to the direction of the axis of rotation (A2) of the first gear wheel (24), and which meshes with the output pinion (22) of the electric motor (16), and in that the first gear wheel (24) is guided in rotation in the casing (12) with a translational laxity according to the direction of its axis of rotation (A2), and in that the actuator (10) includes at least one elastic pressing means (32, 36, 38, 40, 50, 44′, 48′) which urges the first gear wheel (24) according to the direction of its axis of rotation (A2) and which presses the axial toothing (28) of the first gear wheel (24) against the output pinion (22) of the electric motor (16).

2. The actuator according to claim 1, characterized in that the elastic pressing means includes an elastic member (32, 36, 38, 40, 50).

3. The actuator according to claim 2, characterized in that the elastic pressing means is a pressing means whose elastic member (32, 36, 38, 40) delivers an axial return force, directed according to the direction of the axis of rotation (A2) of the first gear wheel (24).

4. The actuator according to claim 3, characterized in that the elastic member (32) is independent of the casing (12) and interposed between the casing (12) and the first gear wheel (24).

5. The actuator according to claim 4, characterized in that the elastic member (32) is a wired spring.

6. The actuator according to claim 5, characterized in that the elastic member is a tension or compression helically-wired spring.

7. The actuator according to claim 3, characterized in that the axial toothing (28) is comprised in an annular area of the first gear wheel (24) which extends, with respect to the axis of rotation (A2) of the first gear wheel (24), between an internal diameter (Dint) and an external diameter (Dext), and in that the elastic member (32) is bearing against the first gear wheel (24) in a central bearing area comprised inside the internal diameter (Dint).

8. The actuator according to claim 7, characterized in that the central bearing area is comprised inside a central diameter less than half the internal diameter (Dint).

9. The actuator according to claim 3, characterized in that the elastic member is bearing against the first gear wheel with the interposition of at least one intermediate part.

10. The actuator according to claim 2, characterized in that the actuator (10) includes a second gear wheel (42′):
which is coaxial (A2) with the first gear wheel (24);
which has a helical cylindrical toothing (44′) formed of gear teeth having a bottom-top extension according to directions perpendicular to the direction of the axis of rotation (A2) of the first gear wheel and having a lateral extension along helical lines wound at a helix angle about the axis of rotation (A2) of the first gear wheel;
which meshes with a third gear wheel (46′) with helical cylindrical toothing (48′);
in that the first (24) and second (42′) gear wheels are secured to each other in rotation about their common axis (A2) and in translation along their common axis (A2);
in that the first (24), second (42′) and third (46′) gear wheels belong to a gear cascade,
and in that the elastic member (50) of the pressing means delivers an angular return force to at least one wheel of said gear cascade about the axis of said gear wheel to which the angular return force is applied, the direction of the return force and the direction of the helix angle of the toothing (42′) of the second gear wheel being chosen so that the angular return force generates, on the first gear wheel (24), an axial pressing force towards the output pinion (22) of the electric motor (16).

11. The actuator according to claim 10, characterized in that the angularly acting elastic member (50) is a wired spring.

12. The actuator according to claim 1, characterized in that the electric motor (16) and the first gear wheel (24) are each connected and positioned independently with respect to the casing (12) of the actuator (10).
